(19) United States
(12) Patent Application Publication
(10) Pub. No.: US 2020/0401990 A1
(43) Pub. Date: Dec. 24, 2020

(54) SYSTEM AND METHODS FOR REAL-TIME CONDITION MONITORING AND TRACEABILITY OF SEAFOOD

(71) Applicant: HAPPY FISH TECHNOLOGIES INC., Dartmouth (CA)

(72) Inventors: Sheamus Colin MACDONALD, Judique (CA); Aleksandr David STABENOW, Lahave (CA)

(21) Appl. No.: 16/961,058

(22) PCT Filed: Jan. 11, 2019
(86) PCT No.: PCT/CA2019/050043

§ 371 Date: Jul. 9, 2020

Related U.S. Application Data
(60) Provisional application No. 62/616,123, filed on Jan. 11, 2018.

(51) Int. Cl. G06Q 10/08; G06K 19/06; G06K 19/07; G06K 7/10

(52) U.S. Cl. CPC G06Q 10/087; G06K 19/06028; G06F 3/0481; G06K 7/10366; G06K 19/06037; G06K 19/0723

(57) ABSTRACT

A system for, and method of, tracking harvested seafood is provided. The system comprises an origin logging unit for logging the origin of a seafood harvest, a quality grading unit for logging the grade of an individual seafood of the seafood harvest, and a quality control subsystem for monitoring conditions of the seafood harvest during storage. The method comprises logging the origin of a seafood harvest, logging the grade of the seafood harvest, and monitoring the seafood harvest during storage.

### FIELD

The present disclosure generally relates to the field of seafood tracking, and in particular to system and methods for real-time condition monitoring and traceability of seafood.

### INTRODUCTION

Embodiments described herein relate to the tracking of harvested seafood. For example, lobsters may be harvested, transported to a vendor, and sold. It is desirable for a way of tracing and monitoring the quality of the lobsters throughout the supply chain harvest to sale.

### SUMMARY

In accordance with an embodiment, there is provided a system for tracking harvested seafood. The system comprises an origin logging unit, a quality grading unit and a quality control subsystem. The origin logging unit comprises a processor configured to cause a display to prompt for origin data of a seafood harvest, receive an input response for the origin data prompt, and cause a transceiver to transmit the origin data to a central data storage location. The quality grading unit comprises a processor configured to cause a display to prompt for quality grading data of an individual seafood of the seafood harvest, receive an input response for the quality grading data prompt, and cause a transceiver to transmit the quality grading data to the central data storage location. The quality control subsystem monitors conditions of the seafood harvest during storage. The quality control subsystem comprises a container for holding the seafood harvest, at least one parameter sensor for measuring an environmental parameter of the container, and a transceiver for transmitting measured environmental parameter data to the central data storage location. An individual seafood is embedded with a tag associated with the origin data, quality grading data and environmental parameter data stored at the central data storage location. Said data stored in the central data storage location is accessible by an electronic device authorized to request said data.

In accordance with an embodiment, there is provided a method of tracking a seafood. The method comprises, at an origin logging unit, displaying a prompt for origin data of a seafood harvest, receiving an input response for the origin data prompt, and transmitting the origin data to a central data storage location. The method further comprises at a quality grading unit, displaying a prompt for quality grading data of an individual seafood of the seafood harvest, receiving an input response for the quality grading data prompt, and transmitting the quality grading data to the central data storage location. The method further comprises at a quality control subsystem for monitoring conditions of the seafood harvest during storage, measuring an environmental parameter of a container holding the seafood harvest, and transmitting measured environmental parameter data to the central data storage location. The method further comprises embedding an individual seafood with a tag associated with the origin data, quality grading data and environmental parameter data stored at the central data storage location. Said data stored in the central data storage location is accessible by an electronic device authorized to request said data.

In accordance with an embodiment, there is provided a system for tracking harvested seafood. The system comprises an origin logging unit for logging the origin of a seafood harvest, a quality grading unit for logging the grade of an individual seafood of the seafood harvest, and a quality control subsystem for monitoring conditions of the seafood harvest during storage.

In accordance with an embodiment, there is provided a method of tracking a seafood. The method comprises logging the origin of a seafood harvest, logging the grade of the seafood harvest, and monitoring the seafood harvest during storage.

In accordance with an embodiment, there is provided a non-transitory computer readable medium comprising instructions which when executed by a processor configure the processor to log the origin of a seafood harvest, log the grade of the seafood harvest, and monitor the seafood harvest during transportation.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a block diagram, an example of a system for tracking seafood, in accordance with some embodiments;

FIG. 2 illustrates, in a flowchart, an example of a method of tracking a seafood, in accordance with some embodiments;

FIG. 3 illustrates, in a component diagram, an example of an origin logging unit, in accordance with some embodiments;

FIG. 4 illustrates, in a screen shot, an example of the questions that may be displayed (prompted) and sample answers that may be inputted in electronic logging of a harvest, in accordance with some embodiments;

FIG. 5 illustrates, in a component diagram, an example of an origin logging environment, in accordance with embodiments;

FIG. 6A illustrates, in a component diagram, an example of quality control subsystem environment, in accordance with some embodiments;

FIG. 6B illustrates, in a screenshot, an example of a water quality sensor display 650, in accordance with some embodiments;

FIG. 7 illustrates, in a component diagram, an example of a seafood tracking system infrastructure, in accordance with some embodiments; and

FIG. 8 is a schematic diagram of a computing device such as a server.

It is understood that throughout the description and figures, like features are identified by like reference numerals.

### DETAILED DESCRIPTION

A consumer or vendor of live seafood may wish to trace the history of the seafood back to the time it was harvested. The present disclosure describes some embodiments of a system and method of tracking the lifecycle of seafood from harvest through the supply chain (e.g., cold chain) to its sale. In this disclosure, the term “tracking” includes the condition monitoring and tracing (traceability) of the seafood. The embodiments are described with reference to the tracking of live seafood, such as lobster. However, it is understood that the embodiments described below may also apply to fish and other seafood that may or may not be live during storage or transportation through the cold chain.

One example of a seafood cold chain comprises a chain of custody including: a harvester who catches the seafood, a dock buyer who purchases the seafood from the harvester, a processor/exporter who processes the seafood and exports the seafood, an importer who imports the seafood, a point of sale, such as a restaurant or a vendor, and the end consumer. It is understood that there are other examples of seafood cold chains that begin with a harvester and end with a consumer.

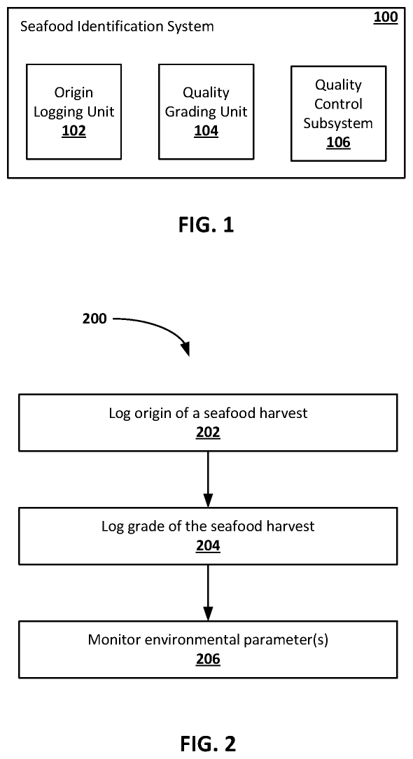

FIG. 1 illustrates, in a block diagram, an example of a system for tracking seafood 100, in accordance with some embodiments. Seafood may comprise lobster, crab or any other seafood that is caught and transported live during the supply chain. The system 100 comprises an origin logging unit 102 for logging the origin of a seafood harvest, a quality grading unit 104 for logging the grade of an individual seafood of the seafood harvest, and a quality control subsystem 106 for monitoring the environmental parameter(s) of conditions experienced by the seafood harvest during storage and transportation throughout the cold chain (i.e., a temperature controlled supply chain). In some embodiments, the system 100 may be used for tracking fish and other seafood that may or may not be live during storage or transportation through the cold chain.

FIG. 2 illustrates, in a flowchart, an example of a method of tracking a seafood 200, in accordance with some embodiments. The method 200 comprises logging the origin 202 of a seafood harvest, logging the grade 204 of the seafood harvest, and monitoring environmental parameter(s) 206 of conditions experienced by the seafood harvest during storage and transportation. In some embodiments, the method 200 may be used for tracking fish and other seafood that may or may not be live during storage or transportation though the cold chain.

Seafood, such as lobster and crab, may be harvested in a catch. The date, time and location of the catch may be tracked and recorded 202 by the origin logging unit 102. The origin logging unit 102 may comprise a handheld unit that accesses an electronic log-book (E-LOG) program remotely by entering a unique identifier code. In some embodimemnts, a custom industrial grade handheld device will be used as the commercial fishing industry experiences harsh conditions. The date, time and location will be stored on the device 102. In some embodiments, when the unit 102 reaches within a distance of another device (for example, within 30 meters of a transceiver device 1003), the date, time and location may be transmitted to that device 1003. This allows for secure transfer of information as well as access for authority.

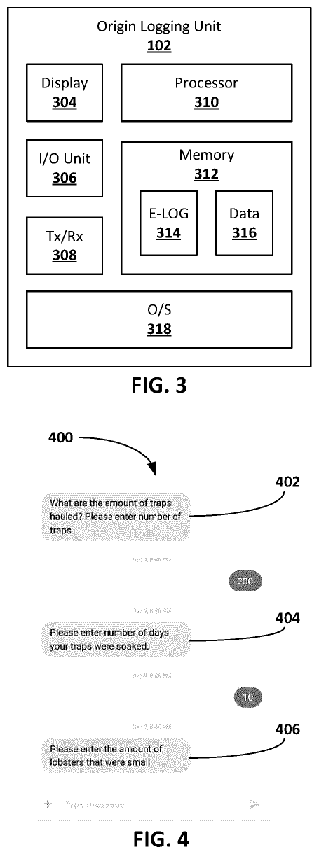

FIG. 3 illustrates, in a component diagram, an example of an origin logging unit 102, in accordance with some embodiments. The origin logging unit 102 comprises a display 304, an input/output (I/O) unit 306, a radio transceiver (Tx/Rx) 308, a processor 310, a memory 312 and an operating system (O/S) 318. The memory 312 may comprise an electronic logging (E-LOG) program 314 (sequence of instructions) that may be executable by the processor 310, and E-LOG data 316. Other components may be added to the origin logging unit 102.

The E-LOG program 314 may be executed on the origin logging unit 102. Once gaining access to the E-LOG program, a harvester may then then answer one or more (e.g., a chain) of questions related to the parameters of their catch that is prompted by the processor 310 and shown on the display 304. The answers may be inputted by the harvester using the input/output unit 306.

FIG. 4 illustrates, in a screenshot, an example of the questions that may be displayed (prompted) and sample answers that may be inputted 400 in electronic logging of a harvest, in accordance with some embodiments. In some embodiments, the E-LOG program 314 may prompt for an input of the amount of traps hauled (e.g., the number of traps) 402. The E-LOG program 314 may also prompt for an input of the number of days that the traps were soaked 404. The E-LOG program 314 may also prompt for an input of the number of lobsters (or other types of seafood that was harvested) that were small 406. Other questions may be prompted by the E-LOG program 314 as required by a governmental body or for business purposes. The example provides questions that may be prompted for a seafood harvested using traps, such as lobster. It is understood that further, fewer and/or different questions may also be prompted, including for any type of fish or seafood in any fishery.

In some embodiments, the origin logging unit 102 is capable of geo-tagging so that the latitude and longitude of the harvester (holding the device) may be automatically included in the data set (information inputted by the harvester into the logging unit 102). The answers inputted into the E-LOG program 314 may be stored in the data 316 portion of the memory 312 of the origin logging unit 102, or in a memory of a server resident on the harvesting vessel that is communicatively coupled to the origin logging unit 102, via a connection between the radio transceiver 308 and a local area network, such as a Wi-Fi or other suitable network, on the harvesting vessel. When the harvesting vessel is within range for transmission to a transceiver device (such as a dockside transceiver unit), the stored information may be transmitted to the transceiver device, from the origin logging unit 102 or the server resident on the harvesting vessel, via any suitable communication network for electronic transmissions between the harvesting vessel and the transceiver device 1003. Before transmission, the stored information may be encrypted using any encryption, blockchain, or encoding technology.

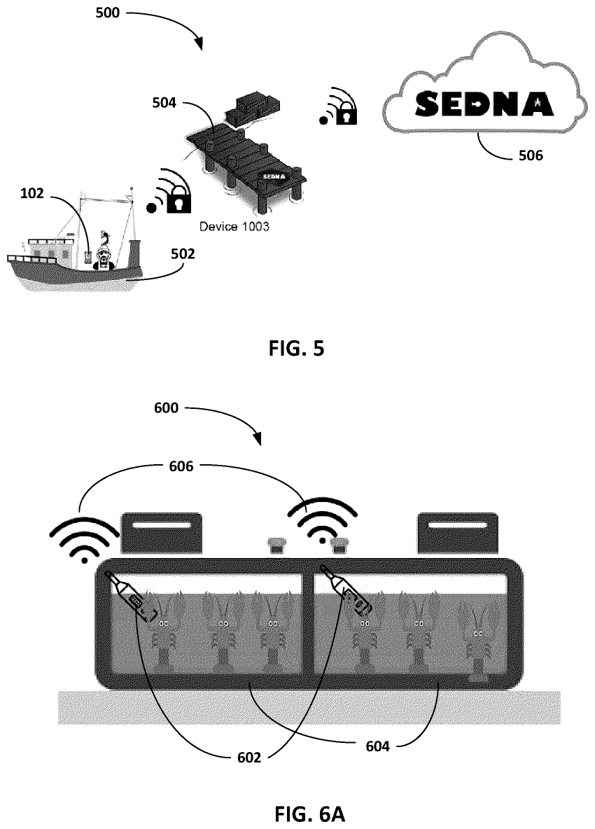

FIG. 5 illustrates, in a component diagram, an example of an origin logging environment 500, in accordance with some embodiments. In some embodiments, once the device 102 is within a distance (e.g., 30 meters or another predetermined distance) of the landing port 504, the information will automatically upload to a secure server 506. This may be performed using transceiver device 1003 that may be installed dockside 504 to allow for data to be transferred quickly and securely. The data may be transmitted to a server in a cloud 506 (such as a Sedona cloud) to be organized for governmental departments (such as the Department of Fisheries and Oceans in Canada) as well as for the harvester 502. Such organization will generate a first set of three data sets for traceability of the seafood.

A dockside application on a dockside transceiver device 1003 may communicate with the harvester application (e.g., ELOG) to collect and submit data captured by the ELOG. In some embodiments, the dockside application may operate independently. For example, a “dockside worker or buyer/processor” may confirm the information submitted by the harvester. In another example, the dockside worker may populate and submit the information from the harvester to a centralized database. Both the ELOG and the dockside transceiver device 1003 may be mobile and operate with radio frequency identification (RFID) handhelds (e.g., iOS or Android devices).

It should be noted that the origin logging unit 102 may also be used to monitor where seafood, or fish, has been harvested. There are areas where it is illegal to fish. To prevent illegally harvested fish or seafood from being mixed with legally harvested fish or seafood, a governmental or industry organization may cross-reference the geolocation data of the inputted data with location data from a government or industry mandated black box on the fishing/harvesting vessel.

When a catch is processed, each seafood may be inspected. Different species have different grading criteria. Some may be by size, health or quality. A “grade” may be assigned to each seafood, seafood batch or entire harvest that could pertain to any single one or combination of the grading criteria. In some embodiments, the grading criteria may also include location, country or fishing area.

The quality grading unit 104 may be used to record 204 at least one of a grade, a quality and a health of an individual seafood inspected in the seafood harvest catch. A date and time stamp of the inspection may also be recorded by the quality grading unit 104. In some embodiments, the seafood in the catch may be separated into separate groups based on their grade, quality and/or health. In some embodiments, the grade may be a quality grade or certification assigned according to an industry or government standard. In some embodiments, market demand may determine a desired separation for grade, quality and/or health. For example, different clients may prefer different sizes of lobster. In this example, lobsters in a catch may be separated according to their size for different clients. The separation by grade, quality and/or health may be determined by market demand and/or industry or governmental regulation.

An RFID tag, laser tag, or other near field technology chip or barcode marking, may be embedded on the seafood by workers at a seafood processing facility with data related to the seafood's grade, quality and health, as well as time stamped data in the chain of custody. The tagging (e.g., barcode/quick response (QR) code) may be used to identify, group, segregate, or account for products. This may be achieved at an item level for a consumer facing approach, or at an item level for a true traceability/accountability approach. In some embodiments, the tag may comprise a memory storing the processing facility data (i.e., quality grading data of the individual seafood). In other embodiments, the tag may be a reference (such as a barcode) associated with the processing facility data stored on a remote server.

The data may be uploaded from the RFID tag submission directly to the server in the cloud 406. The data may be encrypted using any encryption, blockchain, or encoding technology. For example, blockchain technology as a platform may be developed and associated with registering the catch information along with the harvester identifier. This would provide immutable and publically verifiable information storage which may be further referenced in the harvest processor/exporter's information system for backward traceability.

In some embodiments, the RFID tag will be able to be scanned at any point throughout the cold chain of the seafood. This will generate a second data set for traceability of the seafood. At this point, two data sets have been generated that may cross reference against one another for proof of origin and grade of the seafood. Based upon the assessment during processing, the seafood may be separated into different tanks or containers based on their individual grade, quality and/or health. I.e., seafood having the same grade, quality and/or health may be placed in the same container or containers (i.e., water tanks, ice packaging, etc.) for transportation through the cold chain.

Once inspected, the seafood harvest may be transported to locations within the cold chain. During storage at any stage of the cold chain, the seafood may be kept in cold water tanks (e.g., at a processing plant, at a restaurant, etc.). During transportation, the seafood may also be kept in cold water tanks, or the seafood may be shipped in corrugated Styrofoam boxes with ice or ice packs (e.g., during export/import transportation, during transportation from importer to vendor, etc.). It is understood that the seafood may be stored and shipped in other means. The quality control subsystem 106 may be used to monitor the environmental conditions 206 experienced by the seafood harvest during storage at a storage facility and/or during transportation. For example, the temperature, salinity, ammonia, pH, light, dissolved oxygen and other critical parameters of the water in a tank holding the seafood may be monitored, measured and/or transmitted to a central server for monitoring purposes. Also, the temperature of an ice packaging of seafood may be monitored, measured and/or transmitted to the central server for monitoring purposes. Such critical parameter measurements may be date, time and geolocation stamped. In some embodiments, the temperature of the seafood remains between approximately four and eight degrees Celsius from harvest to consumer sale. Levels for temperature, ammonia, pH, dissolved oxygen and/or salinity may be set by government regulation, industry standards and/or market demand.

During transportation from the processing plant though the supply chain, the quality of seafood may be monitored via cold chain logistics and aquatics monitoring. For example, real-time temperature monitoring may take place during holding, shipping and air freight of the seafood. In some embodiments, the core or ambient temperature of a container or trailer that is transporting the seafood may be measured. In some embodiments, environmental conditions of a sea freight system may be measured.

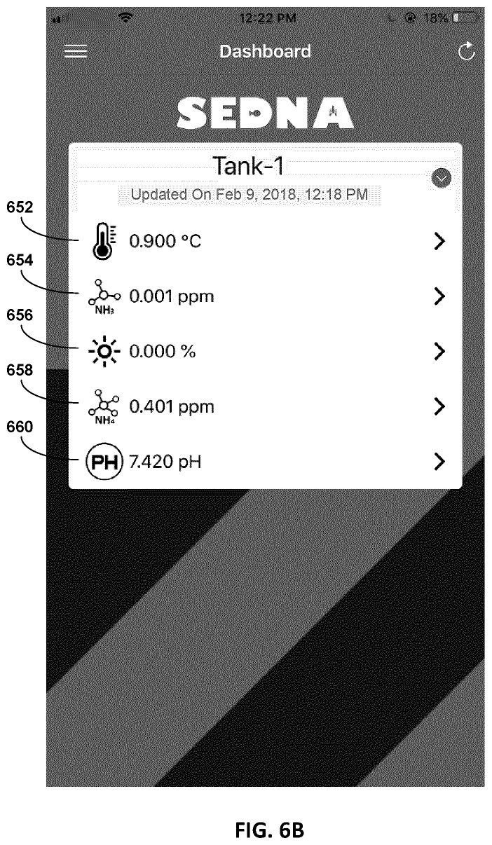

FIG. 6A illustrates, in a component diagram, an example of quality control subsystem environment 600, in accordance with some embodiments. Sensors 602 may be added to tanks 604 (e.g., containers) to measure the temperature, ammonia and salinity of the water, and other critical parameters (e.g., environment parameters). It is understood that for cold packaging with ice, the temperature being measured is that of the package.

Radio transceivers 606 may be connected to the sensors 602 to transmit the environment parameter data. Before transmission, the stored information may be encrypted using any encryption, blockchain, or encoding technology. In some embodiments, the sensors 602 and transceivers 606 form part of an Internet of Things (IoT) environment for periodic (e.g., every 10 to 15 seconds) and/or real-time monitoring. Moreover, at various stages, the temperature and other critical parameter reading data may be time, date and geolocation stamped to determine where and at what stage of the supply chain any changes in temperature or other critical parameters may have taken place. Optionally, the quality control subsystem 106 may further comprise a geolocation unit (not shown) to determine a location of the tank during transportation, and a time and date unit (not shown) to time and date stamp the temperature and other critical data measurements.

IoT may be considered as a connection to the internet or transmission source which allows for the “latest” and most accurate readings available in real-time, not just a historical view. This allows for users of the system to “intercept” any breaches that may affect their product quality or integrity, rather than provide the data after the fact. FIG. 6B illustrates, in a screenshot, an example of a water quality sensor display 650, in accordance with some embodiments. In this example, the water quality sensor displayed include temperature 652, ammonia 654, light 656, ammonium 658 and pH 660, and are monitoring the conditions of a holding tank for lobster in real-time. A user of the system may view this information (e.g., on their handheld device) and be sure they are holding product at the optimal conditions.

The data from all three data sets, can be cross referenced to one another to obtain origin, grading and real-time quality control data throughout the entire cold chain. Such data may be access from an application that obtains the data from the cloud storage.

The informational structure of the data sets may have an Identities object with different parties involved in the process (e.g., Harvester, Processors or Processing unit or plant, Exporter, etc.). The information structure may also include a Transferable entity whose ownership may be associated with identities and allows for the transfer of ownership to be recorded, and in some embodiments, digitally signed by the previous and/or current owner.

A central body managing such a data chain may be responsible to authoritatively govern the creation of the Identities objects on blockchain with globally unique identifiers. The respective roles may also be assigned based on an assessment of real-world facts and supporting documents of the parties issuing identities.

In some embodiments, data extraction from third party hardware may be performed with periodic synchronizations with a data acquisition system of hardware manufacturers via a set of Web application programming interfaces (APIs) exposed by respective manufacturers (and may vary among different manufacturers). Direct data extraction from third party hardware may include the hardware supporting the data acquiring protocols which also follow globally known standards (e.g., Modbus or equivalent).

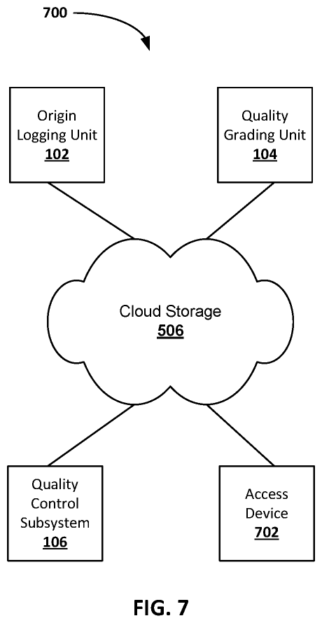

FIG. 7 illustrates, in a component diagram, an example of a seafood tracking system infrastructure 700, in accordance with some embodiments. The infrastructure 700 comprises the origin logging unit 102, the quality grading unit 104, the quality control subsystem 106 and an access device 702, each separately communicatively coupled to the cloud storage 506. The origin logging unit 102 sends origin data to the cloud storage, as described above. The quality grading unit 104 sends quality grading data to the cloud storage 506, as described above. The quality control subsystem 106 sends the environment parameter data to the cloud storage 506. The access device 702 may be used by any authorized entity along the cold chain. In some embodiments, each authorized entity may have different access privileged for different portions of the stored data.

As noted above, in the examples described herein, species held in water are live seafood products. Such species may be crustaceans (e.g., lobster, crab, clams, etc.) but also may be finish (e.g., flounder, carp). In some embodiments, the seafood tracking system may also be implement for the transportation of juvenile fish being transported or stored at a hatchery on their way to a farm or aquarium. While similar species would be held in the same tanks, traceability and condition monitoring is desirable for ensuring quality and best handling practices.

As described above, each of the origin data, quality grading data and environmental parameter data may be encrypted using any encryption, blockchain, or encoding technology. In some embodiments, the encrypted data may be combined at the cloud storage 506 into an individual seafood data that is associated with the tag on the seafood. The tag on the seafood may be scanned by the access device 702 to obtain access to the individual seafood data, associated with the tag, from the cloud storage.

In some embodiments, the tag on the seafood may comprise an RFID chip or other memory means to store the individual seafood data. In this embodiment, an access device may communicate with the RFID chip or other memory means directly to access the individual seafood data. In other embodiments, portions or all of the individual seafood data may be stored on the RFID chip or other memory means, while portions or all of the individual seafood data may be stored at the cloud storage.

In some embodiments, for any seafood that does not appear to be of good quality to a consumer or vendor in the supply chain, the information may be cross-referenced to see where the seafood may have been damaged. I.e., an access device may be used to obtain the individual seafood data for the seafood. For example, if a seafood arrives at a vendor having a lower grade, quality or health than is labelled on the tank or package carrying the seafood, the data associated with the tag on the seafood may be cross-referenced to determine if i) the tank or packaging labelling is incorrect, or ii) if during transportation (anywhere along the cold chain) anything may have occurred to damage the seafood (such as temperature, ammonia and/or salinity levels outside parameters.

In some embodiments, a consumer may wish to know the history of the seafood, and obtain it, either directly from the tag or through the cloud storage, via a scan of the tag on the seafood. This history may include confirmation of origin (location, if legally harvested or not, etc.), grade (quality, health, size at time of harvest/processing, etc.) and environmental conditions (temperature, salinity, ammonia, etc. all within parameters or not at each step in the chain of custody) of the water or packaging during storage/transportation of the seafood.

In some embodiments, the environmental conditions data that is collected may also be made available to customers. For example, conditions may be monitored with readings taken each minute, 30 minutes, or other time interval. The data may be displayed, distributed and accessed, as each reading is taken, by the parties authorized to view the data (e.g., purchasers, government, etc.). If a condition threshold value is breached, a mobile, email or SMS notification may be sent to the parties. Such notification may help the parties make decisions regarding whether or not to purchase, hold or sell the product.

Since quality can differ with different environmental condition readings, the grade (and thus the value of the seafood) may be altered. By connecting the grade (i.e., health, quality, size, etc.) to the real-time environmental conditions, a better approximation of the price/value of the catch may be determined. For example, if harvester A holds the product at 2 degrees onboard the vessel, there may be a higher change that the product will have a high integrity at the time of sale. Whereas if harvester B holds the catch at 8 degrees, this would change the grade of the product (and thus its price/value).

In some embodiments, the real-time environmental conditions data may be used as an indicator of quality and product integrity at the time the data is accessed. For example, using the system 700, a client may know the conditions in which the product has been held, transported or stored. This helps ensure that the cold chain participants are following best practices for the particular product. For example, the water quality on vessels may be measured and assessed. A vessel will know the conditions of its live storage compartments and make informed decisions on when to return to dock to sell their catch to as to provide the highest quality. I.e., not lose product integrity or quality because the vessel extended their trip and held product under bad environmental conditions. In some embodiments, such a decision may be automated, including as part of an autonomous fishing vessel. Alternatively, a purchaser may see the data in real-time and make an informed decision on whether or not to purchase the product, based on the conditions in which it was held.

In some embodiments, the above systems and methods may be used to provide real-time intelligence on the conditions in which a catch was held to confirm the conditions fall within government-certified, industry-standardized or purchaser-demanded guidelines (e.g., Company A only purchases lobster held at certain conditions, from certain areas, etc.). In some embodiments, pricing for a catch may be affected/determined by the environmental conditions associated with its storage or transportation. For example, a purchaser may offer to purchase the catch for a lower price or refuse to purchase the catch. The product may be labeled based on quality associated with the environmental conditions.

In some embodiments, the origin may be from a facility storing product that was purchased from several different vessels. In some embodiments, the above systems and methods may use by a purchases to observe the conditions from multiple suppliers. In some embodiments, trend data may be observed from past conditions to determine ideal environmental conditions in different circumstances. In some embodiments, trend data may be observed to rate a plurality of holder facilities.

The above systems, devices and methods provide for traceability of the seafood for any party in the chain of custody. The seafood data provides data pertaining to the origin, grade and storage/transportation environment of the seafood from harvest to end consumer sale. While the above description involved live seafood, it is understood that similar traceability and packaging environment data may be desirable for other seafood and fish to a consumer or any party in the chain of custody.

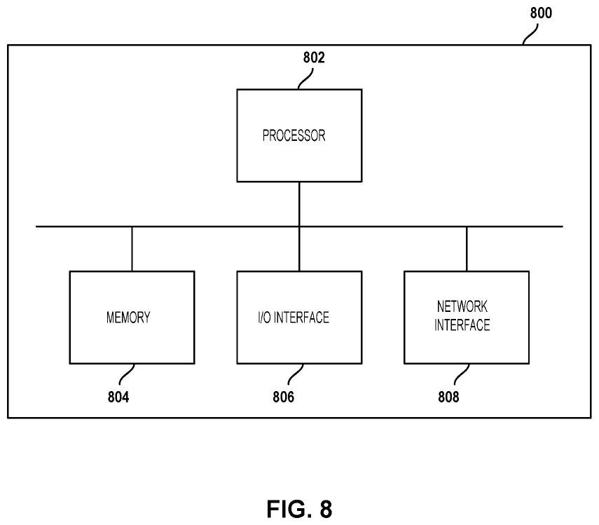

FIG. 8 is a schematic diagram of a computing device 800 such as a server, in which many of the above system, devices and methods may be implemented. As depicted, the computing device includes at least one processor 802, memory 804, at least one I/O interface 806, and at least one network interface 808.

Processor 802 may be an Intel or AMD x86 or x64, PowerPC, ARM processor, or the like. Memory 804 may include a suitable combination of computer memory that is located either internally or externally such as, for example, random-access memory (RAM), read-only memory (ROM), compact disc read-only memory (CDROM).

Each I/O interface 806 enables computing device 800 to interconnect with one or more input devices, such as a keyboard, mouse, camera, touch screen and a microphone, or with one or more output devices such as a display screen and a speaker.

Each network interface 808 enables computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The foregoing discussion provides example embodiments of the inventive subject matter. Although each embodiment may represent a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A system for tracking harvested live seafood comprising:
an origin logging unit comprising a processor configured to:
cause a display to prompt for origin data of a live seafood harvest;
receive an input response for the origin data prompt; and
cause a transceiver to transmit the origin data to a central data storage;
a quality grading unit comprising a processor configured to:
cause a display to prompt for quality grading data of an individual live seafood of the live seafood harvest;
receive an input response for the quality grading data prompt; and
cause a transceiver to transmit the quality grading data to the central data storage; and
a quality control subsystem for monitoring real-time conditions of the live seafood harvest during storage and transport, the quality control subsystem comprising:
a container for holding the live seafood harvest, wherein the container is a water tank;
at least one parameter sensor for measuring, in real-time, an environmental parameter of the container, the at least one parameter comprises at least one of:
a water temperature sensor;
a water ammonia sensor;
a water salinity sensor;
a pH sensor;
a light sensor; or
a dissolved oxygen sensor; and
a transceiver for transmitting, in real-time and periodically during storage and transport, measured environmental parameter data to the central data storage; and
wherein an individual live seafood is embedded with a tag associated with the origin data, quality grading data and environmental parameter data, collected during storage and transport of the live seafood harvest, stored at the central data storage; and
wherein said data stored in the central data storage is accessible, at real-time, by an electronic device authorized to request said data.

2. (canceled)

3. (canceled)

4. A method of tracking a live seafood, the method comprising:
at an origin logging unit:
displaying a prompt for origin data of a live seafood harvest;
receiving an input response for the origin data prompt; and
transmitting the origin data to a central data storage;
at a quality grading unit:
displaying a prompt for quality grading data of an individual live seafood of the live seafood harvest;
receiving an input response for the quality grading data prompt; and
transmitting the quality grading data to the central data storage; and
at a quality control subsystem for monitoring real-time conditions of the live seafood harvest during storage and transport:
measuring, at real-time, an environmental parameter of a container holding the live seafood harvest, wherein the container is a water tank and the at least one parameter comprises at least one of:
a water temperature sensor;
a water ammonia sensor;
a water salinity sensor;
a pH sensor;
a light sensor; or
a dissolved oxygen sensor; and
transmitting, at real-time and periodically during storage and transport, measured environmental parameter data to the central data storage; and
embedding an individual live seafood with a tag associated with the origin data, quality grading data and environmental parameter data, collected during storage and transport of the live seafood harvest, stored at the central data storage; and
wherein said data stored in the central data storage is accessible, at real-time, by an electronic device authorized to request said data.

5. (canceled)

6. (canceled)

7. A system for tracking harvested live seafood comprising:
an origin logging unit for logging the origin of a live seafood harvest;
a quality grading unit for logging the grade of an individual live seafood of the live seafood harvest; and
a quality control subsystem for monitoring real-time environmental conditions of water holding the live seafood harvest during storage and transport.

8. The system as claimed in claim 7, wherein:
the origin logging unit comprises a processor configured to:
record at least one of:
a date of catch of the live seafood harvest;
a time of catch of the live seafood harvest; or
a location of catch of the live seafood harvest;
receive an input of at least one of:
the date of catch from a calendar application running on the logging unit;
the time of catch from a clock application running on the logging unit; or
the location of catch from a qeo-location application running on the logging unit;
prompt a user to input at least one of:
a number of traps hauled during the date of catch;
a number of days the traps were soaked; or
a number of lobsters that were small;
the quality grading unit comprises a processor configured to:
embed one of:
a barcode;
a radio frequency identification (RFID) chip; or
a laser tag;
associated with information pertaining to an inspection of the live seafood harvest, including at least one of:
an individual grade of one live seafood in the live seafood harvest;
an individual quality of the one live seafood in the live seafood harvest;
an individual health of the one live seafood in the live seafood harvest; or
a time stamp of the inspection;
the quality control subsystem comprises:
at least one sensor to monitor and obtain:
water temperature data;
water ammonia data;
water salinity data;
water pH data;
water light data; or
water dissolved oxygen data;
of a container including water holding the live seafood harvest;
a transceiver to periodically transmit during transportation the water data to a server;
a geolocation unit to determine a location of the tank during transportation or storage; and
a time and date unit to time and date stamp the temperature data, ammonia data and salinity data;
wherein said temperature data, ammonia data, salinity data, pH data, water light data; and water dissolved oxygen data are geolocation, time and date stamped prior to transmission to the server.

9. (canceled)

10. (canceled)

11. (canceled)

12. (canceled)

13. (canceled)

14. (canceled)

15. (canceled)

16. (canceled)

17. The system as claimed in claim 7, wherein a plurality of containers are transported, each container comprising live seafood from the live seafood harvest based on at least one of a grade, quality and health of individual live seafood in the live seafood harvest.

18. A method of tracking a live seafood, the method comprising:
logging the origin of a live seafood harvest;
logging the grade of the live seafood harvest; and
monitoring real-time environmental conditions of water holding the live seafood harvest during storage and transportation.

19. The method as claimed in claim 18, comprising:
recording at least one of:
a date of catch of the live seafood harvest;
a time of catch of the live seafood harvest; or
a location of catch of the live seafood harvest;
receiving an input of at least one of:
the date of catch;
the time of catch; or
the location of catch;
prompting a user to input at least one of:
a number of traps hauled during the date of catch;
a number of days the traps were soaked; or
a number of lobsters that were small;
embedding one of:
a radio frequency identification (RFID) chip; or
a laser tag;
with information pertaining to an inspection of the live seafood harvest, including at least one of:
an individual grade of one live seafood in the live seafood harvest;
an individual quality of the one live seafood in the live seafood harvest;
an individual health of the one live seafood in the live seafood harvest; or
a time stamp of the inspection;
monitoring and obtaining data pertaining to at least one of temperature, ammonia, salinity, pH, light, or dissolved oxygen of water in a container carrying the live seafood harvest;
periodically transmitting during transportation or storage the at least one of temperature, ammonia or salinity data to a server;
determining a location of the container during transportation or storage; and
time and date stamping the at least one of temperature, ammonia and salinity data;
wherein said data is geolocation, time and date stamped prior to transmission to the server.

20. (canceled)

21. (canceled)

22. (canceled)

23. (canceled)

24. (canceled)

25. The method as claimed in claim 18, wherein a plurality of containers are transported, each container comprising live seafood from the live seafood harvest based on at least one of a grade, quality and health of individual live seafood in the live seafood harvest.

26. A non-transitory computer readable medium comprising instructions which when executed by a processor configure the processor to:
log the origin of a live seafood harvest;
log the grade of the live seafood harvest; and
monitor real-time environmental conditions of water holding the live seafood harvest during transportation or storage.

27. The system as claimed in claim 1, wherein the harvested live seafood comprises at least one of crustaceans or fish.

28. The system as claimed in claim 1, wherein:
the origin logging unit comprises a processor configured to:
record at least one of:
a date of catch of the live seafood harvest;
a time of catch of the live seafood harvest;
a location of catch of the live seafood harvest; or
receive an input of at least one of:
the date of catch from a calendar application running on the logging unit;
the time of catch from a clock application running on the logging unit; or
the location of catch from a geo-location application running on the logging unit;
prompt a user to input at least one of:
a number of traps hauled during the date of catch;
a number of days the traps were soaked; or
a number of live seafood that were small; and
the quality grading unit comprises a processor configured to:
embed one of:
a barcode;
a radio frequency identification (RFID) chip; or
a laser tag;
associated with information pertaining to an inspection of the live seafood harvest, including at least one of:
an individual grade of one live seafood in the live seafood harvest;
an individual quality of the one live seafood in the live seafood harvest;
an individual health of the one live seafood in the live seafood harvest; or
a time stamp of the inspection.

29. The system as claimed in claim 1, wherein a history of a live seafood in the live seafood harvest is obtainable at real-time from the central data storage, said history comprising at least one of:
origin of the live seafood harvest;
grade at time of live seafood harvest; or
environmental conditions of water holding the live seafood during storage and transportation throughout a supply chain.

30. The system as claimed in claim 1, wherein a notification is sent in real-time when a condition threshold value for an environmental condition of the water holding the live seafood is breached.

31. The method as claimed in claim 4, wherein the harvested live seafood comprises at least one of crustaceans or fish.

32. The method as claimed in claim 4, further comprising:
recording at least one of:
a date of catch of the live seafood harvest;
a time of catch of the live seafood harvest; or
a location of catch of the live seafood harvest;
receiving an input of at least one of:
the date of catch;
the time of catch; or
the location of catch;
prompting a user to input at least one of:
a number of traps hauled during the date of catch;
a number of days the traps were soaked; or
a number of live seafood that were small.
embedding one of:
a radio frequency identification (RFID) chip; or
a laser tag;
with information pertaining to an inspection of the live seafood harvest, including at least one of:
an individual grade of one live seafood in the live seafood harvest;
an individual quality of the one live seafood in the live seafood harvest;
an individual health of the one live seafood in the live seafood harvest; or
a time stamp of the inspection.

33. The method as claimed in claim 4, comprising obtaining a history of a live seafood in the live seafood harvest at real-time from the central data storage, said history comprising at least one of:
origin of the live seafood harvest;
grade at time of live seafood harvest; or
environmental conditions of water holding the live seafood during storage and transportation throughout a supply chain.

34. The method as claimed in claim 4, comprising sending a notification in real-time when a condition threshold value for an environmental condition of the water holding the live seafood is breached.

35. The system as claimed in claim 7, wherein a history of a live seafood in the live seafood harvest is obtainable at real-time from a central data storage, said history comprising at least one of:
the origin of the live seafood harvest;
the grade at time of live seafood harvest; or
the environmental conditions of water holding the live seafood during storage and transportation throughout a supply chain.

36. The system as claimed in claim 7, wherein a notification is sent in real-time when a condition threshold value for an environmental condition of the water holding the live seafood is breached.

37. The method as claimed in claim 18, comprising obtaining a history of a live seafood in the live seafood harvest at real-time from the central data storage, said history comprising at least one of:
origin of the live seafood harvest;
grade at time of live seafood harvest; or
environmental conditions of water holding the live seafood during storage and transportation throughout a supply chain.

38. The method as claimed in claim 18, comprising sending a notification in real-time when a condition threshold value for an environmental condition of the water holding the live seafood is breached.
